(19) United States
(12) Patent Application Publication
(10) Pub. No.: US 2006/0202845 A1
(43) Pub. Date: Sep. 14, 2006

(54) Portable satellite tracking system

(76) Inventor: Chii-Moon Liou, Chunghe City (TW)

Correspondence Address: LEONG C LEI, PMB # 1008, 1867 YGNACIO VALLEY ROAD, WALNUT CREEK, CA, 94598, US

(21) Appl. No.: 11/077,003

(22) Filed: Mar. 11, 2005

(51) Int. Cl. G08B 17/00

(52) U.S. Cl. 340/584; 340/457; 340/573.1; 701/36; 701/49

(57) ABSTRACT

A portable satellite tracking system is disclosed. The portable satellite tracking system for vehicle including a microprocessor at the vehicle end having a satellite positioning module, a digital linking end, a mobile communication module and an anti-burglar apparatus, a monitor end communication system which is linked by phone telephone or mobile phone to the mobile communication module of the vehicle end microprocessor for data transmission; a portable host computer pre-input with electronic map data, characterized in that a DTMF coding module is provided to the vehicle end microprocessor which can convert the positioning data of the satellite positing module to DTMF code and is then delivered via the mobile communication module, the monitor end communication system has a DTMF decoder for restoring DTMF signal to digital signal and delivered to a data transmission end; thereby the direct linkage of the portable host computer with the digital linking end of the vehicle end microprocessor allows satellite positioning guiding or the connection of the data transmission end to monitor tracking at far end and for security.

### BACKGROUND OF THE INVENTION

(a) Technical Field of the Invention

The present invention relates to a satellite tracking system.

(b) Description of the Prior Art

Conventional vehicle satellite tracking system employs GSM vocal data service to transmit satellite positioning data to the computer terminal of the host computer so as to track or position the vehicle. In the conventional system, vocal data service has to be exploited and therefore the cost of operation increases. Further, the conventional satellite tracking system needs the monitor of the host computer to track vehicle and the owner of the vehicle cannot actively locate the position of the vehicle.

### SUMMARY OF THE INVENTION

The primary purpose of the present invention is to provide a portable vehicle satellite tracking system, including a microprocessor at the vehicle end having a satellite positioning module, a digital linking end, a mobile communication module and an anti-burglar apparatus, a monitor end communication system which is linked by phone telephone or mobile phone to the mobile communication module of the vehicle end microprocessor for data transmission; a portable host computer pre-input with electronic map data, characterized in that a DTMF coding module is provided to the vehicle end microprocessor which can convert the positioning data of the satellite positing module to DTMF code and is then delivered via the mobile communication module, the monitor end communication system has a DTMF decoder for restoring DTMF signal to digital signal and delivered to a data transmission end; thereby the direct linkage of the portable host computer with the digital linking end of the vehicle end microprocessor allows satellite positioning guiding or the connection of the data transmission end to monitor tracking at far end and for security.

Still another object of the present invention is to provide a portable satellite tracking system, wherein DTMF communication method of input together with PDA can proactively track or investigate the position of the vehicle.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a microprocessor for vehicle terminal in accordance with the present invention.

FIG. 2 is a flowchart of satellite guided system in accordance with the present invention.

FIG. 3 is a block diagram of the communication system of the monitor end of the present invention.

FIG. 4 is a flowchart of the anti-burglar apparatus of the present invention.

FIG. 5 is a flowchart of the satellite tracking at the remote end in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

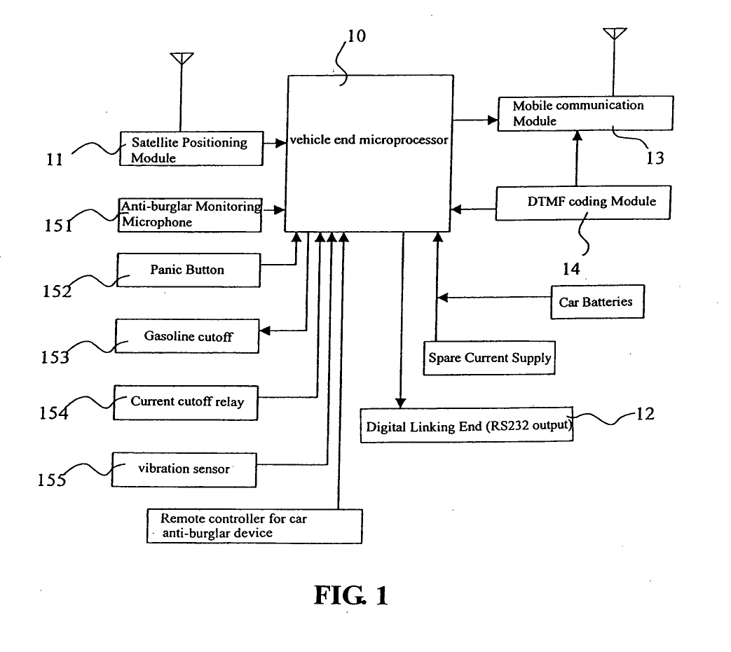

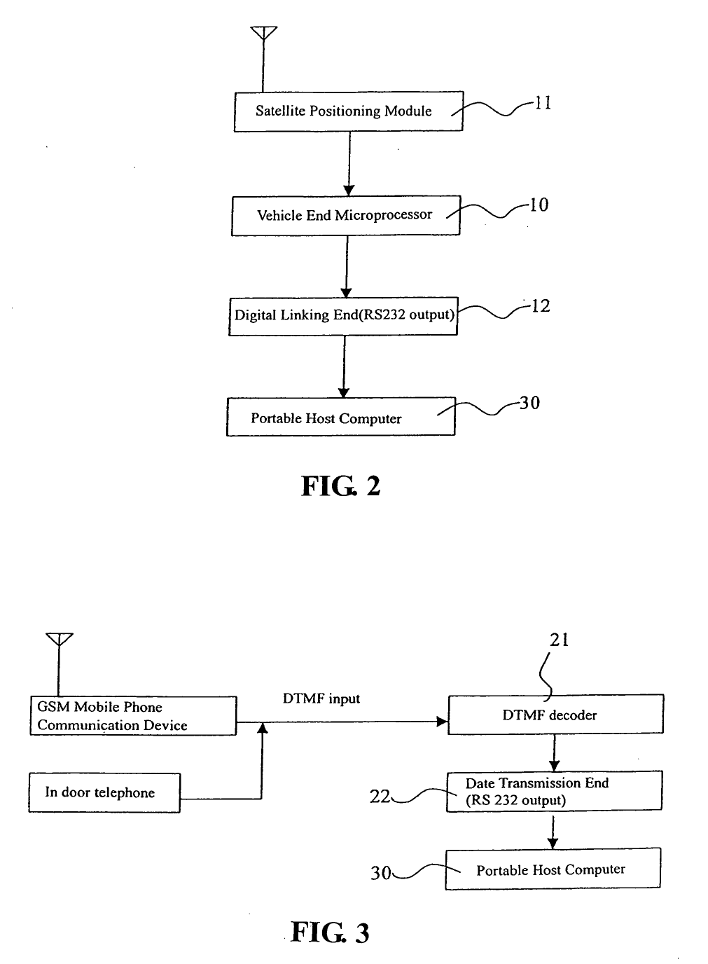

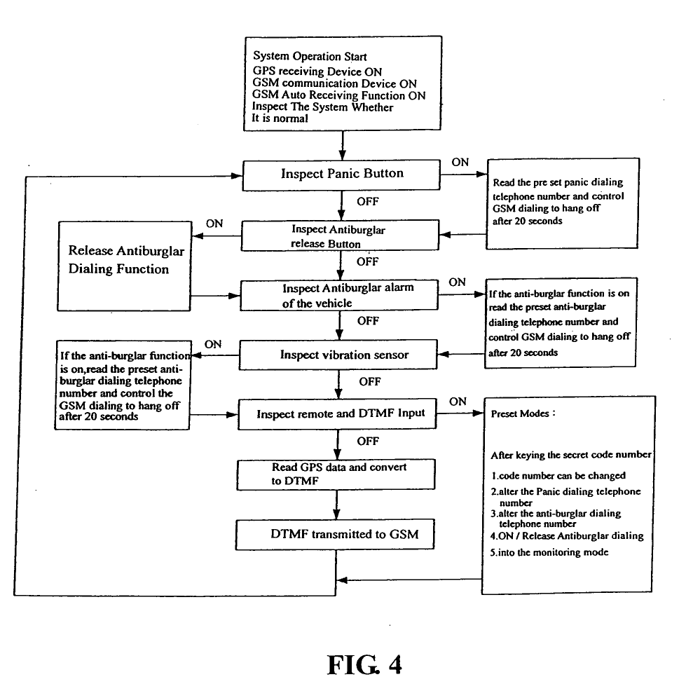

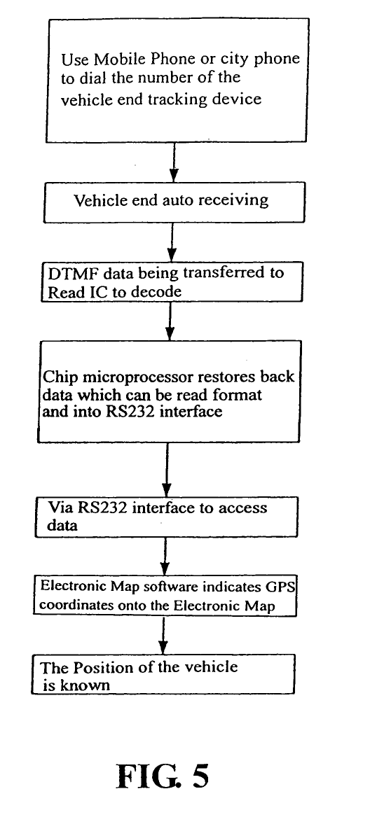

Referring to FIGS. 1 and 2, there is shown a portable satellite tracking system for vehicle including a microprocessor 10 at the vehicle end having a satellite positioning module 11, wherein the satellite positioning module 11 includes a GPS chip which can detect the exact position; a digital linking end 12 which is a RS232 computer communication signal interface, and the satellite positioning data that obtained being directly output as digital signal; a mobile communication module 13 which employs a GSM mobile phone to proceed with voice data in transmission and the vehicle end microprocessor 10 can control the automatic dialing or receive call; a DTMF coding module 14 converting the positioning data of the satellite positing module to DTMF code and then delivered via the mobile communication module 13; and an anti-burglar assembly 15 including a anti-theft monitoring microphone 151, a panic button 152, gasoline interrupter 153, current break delay 154 or vibration sensor panic button 155. The monitor end communication system 20 includes a voice communication line 22 and common lines used at home, and the monitor end communication system 20 which is linked by phone telephone or mobile phone to the mobile communication module 13 of the vehicle end microprocessor for data transmission. The data transmission end 22 is a RS232 computer communication interface.

The portable host computer 30 is a palm computer or note book computer, wherein the computer is pre-input with electronic map data. RS232 computer communication interface is used for linkage.

Referring to FIG. 3, when the owner of the vehicle is driving the vehicle, the portable host computer 20 is linked at the digital linking end 12 so as to input the satellite positioning data from the satellite positioning module 11 to the portable host computer 30 and the electronic map data is pre-inputted by the portable host computer 30 so as to achieve the object of satellite positioning.

When the owner of the vehicle is away from the vehicle the portable host computer 30 is linked to the data input end 22 of the monitoring end communication system 20. Fixed phone line or GSM hand phone can be used to call the GSM mobile phone on the vehicle and the microprocessor I 0 can control the mobile communication module 13. After the dialing is successful, press * and to input code number. If the DTMF has eight echoes, it shows that the code number is correct and the vehicle end microprocessor 10 is in operation.

The user can proceed with the following actions:
(A) Change of code number: After DTMF sound stops, input “01234 1234” and press “*” and there are eight DTMF echoes, it indicates that the setting is completed. The “0” is the control selected item (change of code number). The first group “1234” is new code number and the second group “1234” is confirmed code number. If there are four DTMF echoes, it shows that the change of code number is in error and reset is needed.
(B) Change of dialing back number: After the DTMF sound stops, “10931123456” is input, and then press “*” key and there are eight DTMF echoes sound, it shows that the setting is completed. “1” is the group number, which can be 1 to 6 group, the first 1,2,3 is the anti burglar dialing numbers, and the 4,5,6 group is the panic number. There are ten numbers and if there are only 9 number for the telephone number, then “*” has to be key in. If DTMF has four echoes, it shows the setting is in error.
(C) Cancellation of dialing number: When DTMF sound stops, press “1*” and if DTMF has 8 echoes, the setting is completed. The “1” denotes the dialing code module and the groups 1 to 6 can be cancelled. If the DTMF has four echoes, the setting is in error and resetting has to be done again.
(D) Gasoline cut off: When DTMF sound stops, “7#” is key in, the vehicle will cause the GPS to determine the vehicle in motion or stops or in slow speed at a safety speed, the gasoline cut off is triggered by the interrupter 153 and the current interrupter 154 to stop the gasoline supply so as to protect the vehicle. To disengage the gasoline cutoff protection, when the DTMF sound stops, press “9”.
(E) Monitoring mode: When DTMF sound stops, “8” is key in the vehicle end microprocessor 10 triggers the anti-burglar microphone 151 to proceed to monitoring mode. Press “*” to return to the tracking mode.
(F) Temporary Dialing: When the vibration sensor 155 is triggered, the vehicle end microprocessor 10 triggers the anti-burglar dialing. The receiving end is then pressed with “*” and the vehicle end will be disconnected immediately, and the dialing is temporarily stopped. After a few minutes, the anti-burglar is restored.

The portable host computer 30 can control the anti-burglar assembly 15.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable satellite tracking system for vehicle including a microprocessor at the vehicle end having a satellite positioning module, a digital linking end, a mobile communication module and an anti-burglar apparatus, a monitor end communication system which is linked by phone telephone or mobile phone to the mobile communication module of the vehicle end microprocessor for data transmission; a portable host computer pre-input with electronic map data, characterized in that a DTMF coding module is provided to the vehicle end microprocessor which can convert the positioning data of the satellite positing module to DTMF code and is then delivered via the mobile communication module, the monitor end communication system has a DTMF decoder for restoring DTMF signal to digital signal and delivered to a data transmission end; thereby the direct linkage of the portable host computer with the digital linking end of the vehicle end microprocessor allows satellite positioning guiding or the connection of the data transmission end to monitor tracking at far end and for security.

2. The portable satellite of claim 1, wherein the portable host computer is a palm computer or a note book computer.

3. The portable satellite of claim 1, wherein the mobile communication module can automatically receive the dialed signal so as to monitor tracking communication link and to input anti-burglar command.

4. The portable satellite of claim 1, wherein house phone or mobile phone keyboard input DTMF audio signal is used for transmission to the vehicle end microprocessor so as to control the switch on or close of the anti-burglar apparatus.

5. The portable satellite of claim 1, wherein the anti burglar apparatus includes an anti burglar microphone, panic button, gasoline interrupter, current break delay or vibration sensor.

6. The portable satellite of claim 5, wherein the anti burglar microphone includes a mobile communication module transmission vocal system to proceed with anti-burglar.

7. The portable satellite of claim 5, wherein the vehicle end microprocessor is preset with a plurality of panic code which can dial an urgent number to trigger the anti burglar microphone to urgent linking.

8. The portable satellite of claim 5, wherein the vehicle end microprocessor is provided with a plurality of dialing back code such that when the anti-burglar assembly or the sensor are triggered the preset number is dialed to inform the car owner to investigate.

9. The portable satellite of claim 1, wherein the vehicle end microprocessor receives the gasoline break command, the satellite positioning system detect car speed and when the speed of the car is zero or ten km/hr, the gasoline tube is broken and together with the delay, the vehicle is stopped.
